(19) United States
(12) Patent Application Publication
(10) Pub. No.: US 2023/0287285 A1
(43) Pub. Date: Sep. 14, 2023

(54) Pyrolysis Plants and Methods for Thermal Mineralization of Biomass and Production of Combustible Gases, Liquids and Biochar

(71) Applicant: Frichs Holding 2 ApS, Horsens (DK)

(72) Inventor: Ove KUDAHL MUNCH, Tilst (DK)

(21) Appl. No.: 18/139,447

(22) Filed: Apr. 26, 2023

Related U.S. Application Data
(63) Continuation of application No. PCT/DK21/50317, filed on Oct. 27, 2021.

(30) Foreign Application Priority Data
Nov. 2, 2020 (DK) PA 2020 01242

(51) Int. Cl. C10J 3/48; C10J 3/46; C10J 3/50; C10J 3/74; C10J 3/52

(52) U.S. Cl. CPC C10J 3/485; C10J 3/466; C10J 3/506; C10J 3/74; C10J 3/526; C10J 2300/092; C10J 2300/1246; C10J 2300/1823; C10J 2300/1884; C10J 2200/152; C10J 2200/158; C10J 2200/09

(57) ABSTRACT

Methods and pyrolysis plants are described, comprising reactors for producing pyrolysis gas from biomass. The reactors comprise one or more reaction channels linked thermally with at least one heating circuit, which is configured to heat the reaction channels to a temperature that is high enough to gasify the biomass. The reactors comprise a feed section configured for feeding the biomass into the reaction channels. The pyrolysis plants comprise a gas accelerator configured for recirculating the gas that is present in the at least one reaction channel and for providing a gas flow velocity that is able to distribute the biomass in the reaction channel.

### CROSS-REFERENCE TO RELATED APPLICATIONS

This application is a continuation under 35 U.S.C. 111 of International Patent Application No. PCT/DK2021/050317, filed Oct. 27, 2021, which claims the benefit of and priority to Danish Application No. PA 2020 01242, filed Nov. 2, 2020, each of which is hereby incorporated by reference in its entirety.

### FIELD OF INVENTION

The present disclosure relates to a pyrolysis plant and a method for thermal mineralization of biomass and production of combustible gases, liquids and biochar.

### BACKGROUND

Pyrolysis is a well-known process, which is used for converting organic materials into energy in the form of gas. Many methods and reactor designs have been developed over the course of time.

Pyrolysis makes it possible to convert biomass such as straw, farmyard manure, energy crops or organic residues to a gas, which can be used for example in a combined heat and power station. The ash from the process is rich in nutrient salts and is therefore suitable for use in connection with crop growing.

In a typical pyrolysis plant, comminuted biomass is fed into a pyrolysis chamber, which is heated in the absence of oxygen. As no oxygen is present, the biomass does not burn. Instead, the biomass is converted to approx. 80% pyrolysis gas and 20% coke (carbon). Sand particles are injected from the bottom of the pyrolysis chamber, for the purpose of swirling the coke particles and entraining them out of the pyrolysis chamber. The pyrolysis gas formed and the coke are withdrawn from the upper part of the pyrolysis chamber and transferred to a first cyclone, where the sand and coke particles are separated and go down into a coke reactor, while the pyrolysis gases are transferred to another cyclone, where the ash, which contains nutrient salts, is separated and is transferred to a container. The gases leaving the other cyclone can now be used in for example combined heat and power stations.

The coke reactor is configured for gasifying the coke. The gas is led to the pyrolysis chamber. Air is fed into the coke reactor.

EP0561849 describes a pyrolysis apparatus for rapid conversion of petrochemical-based waste to gas and liquid fuel. Biomass is sent through an externally heated vessel consisting of one or more helical tubes, which are relatively narrow to promote heat transfer between the walls of the helical tubes and the raw material. The tube dimensions and the velocity of the carrier gas are selected with a view to forcing the raw material against the internal surface of the equipment with a centrifugal force in the range 100-1000 g (the acceleration of gravity) for heat transfer. The temperature in the reactor vessel is in the range 300 to 950° C. However, it is also envisaged that a heated, non-oxidizing, air-containing gas may provide some or all of the heating of the reaction.

U.S. Pat. No. 5,413,227 describes a pyrolysis plant for rapid conversion of biomass and waste-derived raw materials to gas and biochar by means of a vertically arranged, externally heated vortex reactor, where the carrier gas, which may be superheated steam at approx. 525° C., and the raw materials move in a helical path down through the reactor, the walls of which maintain a temperature of approx. 625° C. The vertical arrangement of the reactor facilitates removal of inert particles, metal fragments and condensed pyrolysis oils. Wearing plates are fitted to protect parts of the reactor that are particularly exposed to wear from the feed materials.

U.S. Pat. No. 8,999,017 describes an externally heated rotary kiln for rapid pyrolysis of biomass and sorted solid household waste, where the process is controlled for maximizing the production of oil.

U.S. Pat. No. 8,298,406 describes a similar externally heated rotary kiln for rapid pyrolysis of oil shale and coal, where the external burners are placed and operated for maintaining the optimum wall temperatures for producing hydrocarbon gases.

US20150096879 describes a rapid pyrolysis reactor tube with various geometric configurations, which offer the possibility of rapid heat transfer from external heat sources to at least one of the surfaces of the reactor tube. Insulation may be used to prevent heat loss and assist the heating process.

GB1517765 describes feeding of pulverized coal to a gasification apparatus. There is mention of an apparatus for gasification of pulverized coal with partial combustion with oxygen (or a gas containing oxygen). The coal is supplied via a central tube into a reactor chamber, where oxygen and possibly steam are led through an external tube. The coal is conveyed in an oxygen stream. The design can be round and 3-10 times the diameter of the tube.

EP 0904335 A1 discloses a process for thermolysis of shredded biomass by using a deep fluidized bed. The process includes a step, in which the produced gas flows through a scrubbing tower or liquid quencher, in which the temperature of the gas is reduced to less than 60° C. Therefore, a heat exchanger is required to heat up the gas before introducing the gas into the thermolysis reaction. Accordingly, the energy efficiency is poor and thus it would be advantageous to provide a process having an improved energy efficiency.

US 2017166818 A1 discloses a pyrolysis reactor, in which the produced gas flows through a condenser, in which the temperature of the gas is reduced to about 0° C. Therefore, a heat exchanger is required to heat up the gas before introducing the gas into the reaction. Accordingly, the energy efficiency is poor and thus it would be advantageous to provide a pyrolysis plant having an improved energy efficiency.

It is desirable to minimize the occurrence of undesirable tar products, called polyaromatic hydrocarbons (PAHs). Moreover, it is desirable to be able to produce a gas with a high calorific value measured in MJ per fuel unit (e.g. per m³) and produce an installation where the process can be controlled as well as possible, taking into account the raw material supplied and the desired end products.

### BRIEF DESCRIPTION

The aim of the disclosed devices and methods is to be able to carry out a pyrolysis process under conditions that minimize the occurrence of undesirable PAH tar products, give a gas with a high calorific value, and provide an installation in which the process can be controlled as well as possible taking into account the raw material supplied and the desired end products. Furthermore, the aim is to be able to carry out a pyrolysis process in which the occurrence of undesirable PAH tar products in the biochar formed can be reduced relative to known processes. It is an object of the disclosure to provide a process and a pyrolysis plant having an improved energy efficiency.

A pyrolysis plant according to an embodiment is a pyrolysis plant comprising a reactor for producing pyrolysis gas from biomass, where the reactor comprises one or more reaction channels linked thermally with at least one heating circuit, which is configured to heat the reaction channels to a temperature that is high enough to gasify the biomass, where the reactor comprises a feed section configured for feeding the biomass into the reaction channels, where the pyrolysis plant comprises a gas accelerator configured for recirculating the gas that is present in the at least one reaction channel and for providing a gas flow velocity that is able to distribute the biomass in the at least one reaction channel, wherein the pyrolysis plant comprises a carbon separator and a gas preheater, wherein from a top of the carbon separator, the pyrolysis gas is recirculated further to the gas preheater, wherein a plurality of nozzles is provided in the heating circuit, where each nozzle is configured to supply gas to the heating circuit.

As a result, it is possible to minimize the occurrence of undesirable tar products, since the biomass is exposed to high temperature for a short time. Thus, a brief gasification process is carried out, compared to gasification processes in pyrolysis plants known until now.

Research has shown that it is possible to produce a gas with a high calorific value. In fact, values have been measured (20 MJ/m³) that are more than four times greater than the values for conventional installations (4.5 MJ/m³).

Finally, the disclosed devices and methods make it possible to produce a pyrolysis plant that makes improved control of the pyrolysis process possible. The reactor is characterized in that it can be started and stopped in a flexible manner. As the gasification of biomass takes place in the reaction channel, when the oxygen content in the reaction channel is kept at a low level simultaneously with the temperature in the reaction channel being suitably high, it is possible to stop the production of pyrolysis gas very quickly by adjusting the feed of biomass.

A pyrolysis plant according to an embodiment is configured for producing pyrolysis gas from biomass such as e.g. straw, wood chips, farmyard manure, energy crops or other products that contain carbon and hydrogen.

The reactor comprises one or more reaction channels linked thermally with at least one heating circuit, which is configured to heat the reaction channels to a temperature that is high enough to gasify the biomass.

In an embodiment, the reactor comprises a single reaction channel linked thermally with at least one heating circuit.

In an embodiment, the reactor comprises a plurality of reaction channels, each individually linked thermally with one or more heating circuits.

The reactor comprises a feed section configured for feeding the biomass into the at least one reaction channel. The feed section is generally configured to limit the supply of oxygen, so that the oxygen concentration in the gas that is fed into the at least one reaction channel is far lower than the oxygen concentration in the atmospheric air.

The pyrolysis plant comprises a gas accelerator configured for providing a gas flow velocity that is able to blow the biomass around in the reaction channel(s).

Distribution of biomass in the at least one reaction channel may be provided using a blower (e.g. an electric blower, where the motor is equipped with a frequency converter). The gas accelerator may thus be a blower.

The gas accelerator may comprise a mechanical device, which for example comprises a fan.

It may be advantageous if the heating circuit is configured to carry out heating by gas burning.

In an embodiment, the heating circuit is configured for carrying out heating by burning pyrolysis gas produced by the pyrolysis plant.

It may be advantageous if the pyrolysis plant comprises an oxygen minimizing device, which is in fluid communication with the feed section, where the oxygen minimizing device is configured to maintain the oxygen concentration in the air that is fed together with the biomass into the at least one reaction channel via the feed section below a predefined level.

In this way it is possible to ensure that the oxygen concentration in the reaction channel(s) remains within the desired range.

It may be advantageous if the oxygen minimizing device is in fluid communication with a tube that receives flue gas from the heating circuit. In this way, flue gas from the heating circuit is utilized for regulating oxygen.

It may be advantageous if the oxygen minimizing device is connected to or integrated in a feed system that is configured for feeding biomass into the reaction channel(s), where the feed system comprises:
a silo for receiving, storing and supplying biomass,
a metering screw mounted rotatably in a screw channel, and
a feed screw mounted rotatably in a screw channel,
   where the feed system is pressurized by the oxygen minimizing device.

As a result, it is possible to keep the oxygen concentration in the at least one reaction channel at as low a level as possible, when the biomass is fed into the at least one reaction channel. This ensures optimum conditions for formation of pyrolysis gas.

It may be advantageous if, in the at least one reaction channel, one or more ejection sections are provided, which are configured to lead pyrolysis gas out of the at least one reaction channel by ejection (when the gas pressure exceeds a predefined level).

It may be advantageous if the gas accelerator is a blower, which is mounted and configured for providing a gas flow velocity that is able to transport the biomass around in the at least one reaction channel.

In an embodiment, the reactor comprises a plurality of reaction channels, where each reaction channel is placed in a heat exchanger, which is mounted in thermal contact with and therefore exchanges heat with one or more surrounding heating circuits. As a result, it is possible to minimize heat loss to the surroundings and at the same time provide a large reaction volume.

In an embodiment, the pyrolysis plant comprises a carbon separator, which is connected to the reactor in such a way that pyrolysis gas that is formed in the reactor is transferred to the carbon separator, wherein the carbon separator comprises an outlet for withdrawal of pyrolysis gas by ejection.

It may be advantageous if the blower is connected to the carbon separator in such a way that the blower receives pyrolysis gas that is formed in the reactor, and so that the blower is mounted and configured for recirculating the pyrolysis gas in the reactor.

In an embodiment, the pyrolysis plant comprises a preheater, which is mounted between the blower and the reactor, wherein the preheater is configured to receive gas from the blower and heat the gas, before the gas is fed back into the reactor.

As a result, it is possible to ensure that the gas is fed back into the reactor with the desired temperature, so that the pyrolysis process can be optimized.

It may be advantageous if the pyrolysis plant comprises a heater, which is mounted in thermal contact with the preheater. This makes it possible to initiate and control the preheater.

In an embodiment the heater is heated electrically.

In an embodiment the heater is heated by fuel(s).

It may be advantageous if the blower is connected to the upper part of the carbon separator.

In an embodiment, a carbon outlet is provided in the lower part of the carbon separator. This makes it possible to withdraw carbon simply and reliably.

It may be advantageous if the pyrolysis plant comprises a control unit, which is connected to and configured for regulating the blower, wherein the control unit is connected via a connection to a regulating unit, which is configured to regulate the temperature of the preheater. This makes it possible to ensure optimum operating conditions. The pyrolysis process can thus be optimized.

It may be advantageous if the control unit is connected to a temperature sensor, which is mounted and configured to measure at least one temperature in the reactor. In this way it is possible to ensure that the reactor temperature is within the desired temperature range.

It may be advantageous if the pyrolysis plant comprises a temperature regulating unit, configured for maintaining the temperature of the gas in the reactor in a range defined beforehand between a predefined lower temperature (T₁) and a higher predefined upper temperature (T₂). This makes it possible to ensure optimum operating conditions. The pyrolysis process can thus be optimized.

It may be advantageous if the pyrolysis chamber comprises at least one flow sensor, fitted to measure a flow in the reactor.

It may be advantageous if the pyrolysis chamber comprises at least one pressure difference sensor, fitted to measure a differential pressure in the reactor.

It may be advantageous if the thermal energy from flue gas from the heating circuit is used by heat exchange for heating air that is injected into the heating circuit. This may be achieved advantageously using a gas heat exchanger. As a result, it is possible to increase the energy efficiency of the system.

It may be advantageous if the thermal energy from the pyrolysis gas formed, which is ejected from the reactor, is used by heat exchange for heating the biomass that is fed into the at least one reaction channel. This may be achieved advantageously using a jacket, which surrounds a screw configured for feeding biomass into the reactor. In an embodiment, this jacket is a double jacket (a jacket with two parallel layers, through which the pyrolysis gas flows).

It may be an advantage that a plurality of nozzles is provided in the heating circuit, where each nozzle is configured for supplying gas to the heating circuit. As a result, it is possible to control, on the one hand, the amount of gas that is fed into the heating circuit and, on the other hand, the distribution of the gas (i.e. where the gas is introduced).

In an embodiment, the nozzles are fitted in such a way that the gas that is fed into the heating circuit via the nozzles is distributed evenly along the heating circuit. This can be achieved by placing the nozzles in a row of feed zones along the heating circuit.

By using a plurality of individual, separate nozzles for feeding gas into the heating circuit it is possible to avoid local overheating (hot spots) in the heating circuit.

In an embodiment, the nozzles are fitted in such a way that there is a mutual distance between adjacent nozzles of 50-200 cm.

In an embodiment, all the nozzles are configured to feed gas in simultaneously. In an embodiment, all the nozzles are configured to feed gas in at the same flow (feed rate).

It may be advantageous if the nozzles supply pyrolysis gas that is produced in the reaction channel.

A method according to an embodiment is a method for producing pyrolysis gas using a pyrolysis plant comprising a reactor for producing pyrolysis gas from biomass, where the reactor comprises at least one reaction channel linked thermally with at least one heating circuit, which is configured to heat the at least one reaction channel to a temperature that is high enough to gasify the biomass, where the reactor comprises a feed section configured for feeding biomass into the at least one reaction channel, where the method comprises a step in which a gas flow is generated, which carries the biomass around in the at least one reaction channel, wherein the pyrolysis plant comprises a carbon separator and a gas preheater, where from a top of the carbon separator, the pyrolysis gas is recirculated further to the gas preheater, wherein a plurality of nozzles is provided in the heating circuit, where each nozzle is configured to supply gas to the heating circuit.

As a result, it is possible to provide a method that makes it possible to minimize the occurrence of undesirable tar products, since the biomass is exposed to high temperature for a short time. Thus, a brief gasification process is carried out, compared to the gasification process in pyrolysis plants known hitherto.

It may be advantageous if the gas flow is generated using a blower, which is installed in the at least one reaction channel. This makes it possible to regulate the gas flow velocity simply and reliably.

It is important to emphasize that the gas flow that drives the biomass around in the at least one reaction channel ensures that the biomass is distributed, so that it does not (as is the case in conventional equipment) lie in heaps, with the result that parts of the biomass are insulated by the underlying biomass.

The gas flow further ensures that there is recirculation of the pyrolysis gas that is formed in the at least one reaction channel. As a result, it is possible to maintain a process in which the pyrolysis gas is recirculated in the at least one reaction channel. However, ejection of pyrolysis gas takes place when the gas pressure in the at least one reaction channel exceeds a predefined level.

By using a blower to generate the gas flow, it is possible to utilize the blower as an active heating source, so that the electrical energy that is converted by the blower to mechanical work is subsequently converted to heat. The heat is generated when the flow velocity of the gas is reduced as a result of friction.

It may be advantageous if the biomass is transported around in the at least one reaction channel in the reactor by means of a carrier gas, which is produced in the at least one reaction channel, wherein the carrier gas is recirculated in the at least one reaction channel. This makes it possible to allow the pyrolysis gas produced in the at least one reaction channel to recirculate and at the same time use the pyrolysis gas as carrier gas, which carries the biomass around in the at least one reaction channel.

It may be advantageous if the temperature of the carrier gas is maintained in a predefined temperature range.

It may be advantageous for the temperature of the carrier gas to be increased in a section of the at least one reaction channel during recirculation of the carrier gas. As a result, it is possible to ensure that the temperature of the carrier gas is high enough so that biomass that is fed into the at least one reaction channel is gasified as rapidly as possible.

It may be advantageous for the oxygen concentration of the gas that is fed into the feed section to be kept as low as possible and below a predefined level, which is lower than the oxygen concentration of atmospheric air.

It may be advantageous if the carrier gas is recirculated in the reactor, and if the temperature of the carrier gas is maintained in a predefined temperature range.

It may be advantageous if the carrier gas is recirculated in the reactor by a blower. This makes it possible to control the flow rapidly and precisely. The blower may for example be equipped with a permanent magnet motor and a frequency converter.

In an embodiment, the preheating of the carrier gas is effected by a preheater, which is mounted between the blower and the reactor, wherein the preheater is configured to receive gas from the blower and heat the gas, before the gas is fed into the reactor.

As a result, it is possible to ensure that the gas is recirculated in the reactor with the desired temperature, so that the pyrolysis process can be optimized.

It may be advantageous if the preheater is heated by a heater that is mounted in thermal contact with the preheater.

It may be advantageous if the gas from the upper part of the carbon separator is blown into the reactor. This ensures that the carbon content that is recirculated in the reactor is minimized.

It may be advantageous if the temperature of the preheater is regulated by a control unit, which is connected to and configured for regulating the blower, wherein the control unit is connected via a connection to a regulating unit, which is configured to regulate the temperature of the preheater.

It may be advantageous if the temperature of the preheater is regulated with the use of a temperature sensor, which is fitted and configured for measuring at least one temperature in the reactor.

It may be advantageous if a temperature regulating unit is used in order to maintain the temperature of the gas in the reactor in a range defined beforehand between a predefined lower temperature and a higher, predefined upper temperature.

In an embodiment, gas is supplied to the heating circuit by a plurality of nozzles, which are mounted and configured for feeding gas into the heating circuit.

As a result, it is possible, on the one hand, to control the amount of gas that is fed into the heating circuit and, on the other hand, the distribution of the gas (i.e. where the gas is introduced).

In an embodiment, the gas is supplied to the heating circuit using a plurality of nozzles, where the nozzles are mounted in such a way that the gas that is fed via the nozzles into the heating circuit is distributed evenly along the heating circuit. This can be achieved by placing the nozzles in a row of feed zones along the heating circuit.

### BRIEF DESCRIPTION OF THE DRAWINGS

The invention will be explained hereunder, referring to the appended drawings, where

FIG. 1 shows a schematic sectional view of a reactor according to an embodiment,

FIG. 2 shows a close-up view of a part of a reactor corresponding to the reactor shown in FIG. 1,

FIG. 3 shows a schematic view of a reactor according to an embodiment,

FIG. 4 shows a schematic diagram of a biomass feed unit according to an embodiment, and

FIG. 5 shows a schematic diagram of a filter system for withdrawing and separating biochar according to an embodiment.

### DETAILED DESCRIPTION

By way of introduction, it should be noted that the appended drawings only illustrate non-limiting embodiments. A number of other embodiments will be possible within the scope of the present disclosure. In the following, equivalent or identical elements in the various embodiments will be designated with the same reference symbol.

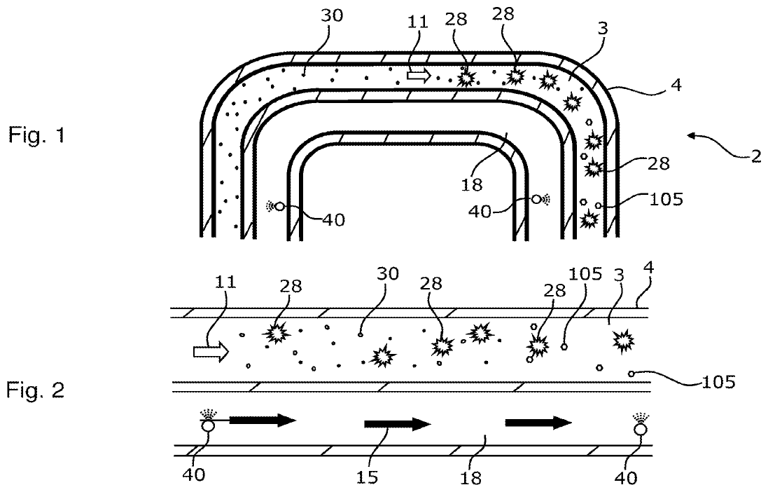

FIG. 1 shows a schematic diagram of a reactor 2 according to an embodiment. The reactor 2 comprises a reaction channel 3, which is placed in a heat exchanger 4, which exchanges heat with the surrounding heating circuit 18. It is emphasized that FIG. 1 is a schematic view, and that the reactor 2 may in practice comprise many layers of reaction channels 3, which are surrounded by the surrounding heating circuit 18. In an embodiment, the reactor 2 comprises many layers of reaction channels 3 and heating circuits 18, provided in such a way that most of the reaction channels 3 are surrounded by heating circuits 18 with a view to minimizing heat loss to the surroundings and at the same time providing a large reaction volume.

In an embodiment, the reactor 2 only comprises one continuous reaction channel 3.

In contrast to the pyrolysis plants known hitherto, the comminuted biomass 30 is fed into reaction channel 3 of the reactor in a section that contains a carrier gas, which is recirculated through the reaction channel 3. The carrier gas will in practice be the pyrolysis gas that forms in the reaction channel 3. In an embodiment there is recirculation of the carrier gas as it leaves the reaction channel 3 by ejection as a result of the increase in pressure that occurs in the reaction channel 3, when more and more biomass 30 is gradually gasified.

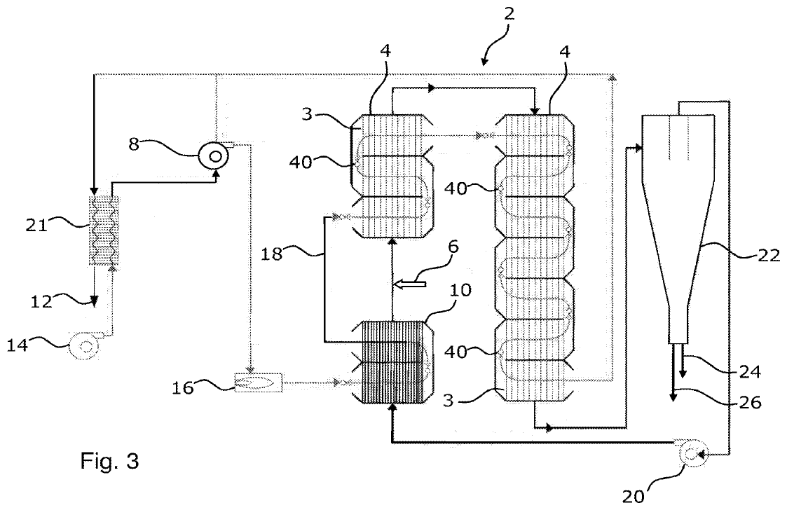

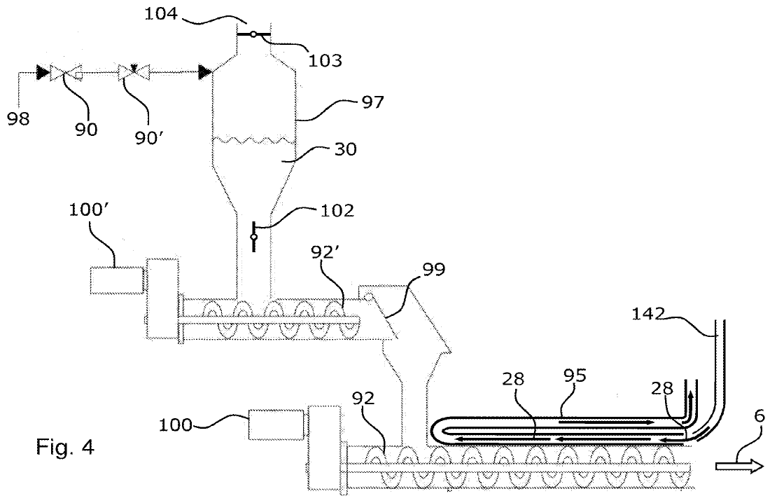

Feed of comminuted biomass 30 may be affected by a metering screw 92′ (see FIG. 4). Recirculation of the carrier gas can be provided by a gas accelerator, which may for example be configured as a blower 20, which is placed inside the reaction channel 3. The blower 20 (see FIG. 3) generates a pressure gradient and therefore a gas flow velocity 11, which on the one hand makes it possible to maintain recirculation of the carrier gas and on the other hand ensures that the comminuted biomass 30 is distributed in the reaction channel 3 of the reactor. The biomass 30 is gasified and forms pyrolysis gas 28 under the conditions in the reaction channel 3, which thus constitutes the pyrolysis chamber of the reactor.

The reactor 2 is characterized in that it provides very rapid heating of the biomass 30 compared to conventional pyrolysis plants, where the biomass is introduced with a screw and then lies in a relatively thick layer. As the biomass in conventional installations is introduced in a manner in which a relatively thick layer of biomass forms on the reactor bottom, the heating of the biomass does not take place uniformly (as the biomass has an insulating effect and therefore it is far colder in the middle of the layer than in the uppermost part of the layer). Owing to this temperature gradient, moreover, the heating time is relatively long compared to the heating time in a reactor 2 according to the present disclosure. Put briefly, heating of the comminuted biomass 30 takes place many times more quickly and much more evenly in a reactor 2 according to the present disclosure than in conventional pyrolysis plant.

In an embodiment, the heating circuit 18 is heated with gas that is burned in a controlled environment, where the oxygen concentration is maintained in a predefined range, e.g. approx. 4%.

The heating circuit 18 is provided with nozzles 40, which are configured for supplying gas to the heating circuit 18. As a result, it is possible on the one hand to control the amount of gas that is fed into the heating circuit 18 and on the other hand the distribution of the gas (i.e. where the gas is introduced). The aim is for the nozzles 40 to be installed in such a way that the gas is distributed evenly by being introduced in a row of feed zones (corresponding to the placement of the nozzles). In this way it is possible to avoid local overheating (hot spots). In an embodiment the nozzles 40 are installed in such a way that there is a mutual distance between adjacent nozzles 40 of 50-200 cm. In an embodiment, all the nozzles 40 are configured for introducing gas simultaneously. In an embodiment, all the nozzles 40 are configured for introducing gas with the same flow (feed rate). It may be advantageous if the nozzles 40 supply pyrolysis gas 28 that is produced in the reaction channel 3.

On the left side of the section of the reaction channel 3 shown, there is a relatively high concentration of biomass 30. On the right side of the section of reaction channel 3 shown, there is on the other hand a lower concentration of biomass 30, while conversely there is a higher concentration of pyrolysis gas 28 and biochar (carbon) 105. This is because the biomass 30 has been converted to pyrolysis gas 28 and biochar (carbon) 105, respectively.

FIG. 2 illustrates a close-up view (sectional view) of a part of a reactor corresponding to the reactor shown in FIG. 1. The reactor comprises a heat exchanger 4, which is in thermal contact with an adjoining heating circuit 18, which consists of a channel that extends parallel to the heat exchanger 4. In the heat exchanger 4, a reaction channel 3 is provided, into which comminuted biomass 30 is fed, which is gasified when a sufficiently high temperature (typically above 800° C.) is provided, and at the same time the oxygen content is kept low.

In FIG. 2, gasification of biomass 30 has occurred, which is thus converted to pyrolysis gas 28 in the reaction channel 3. The comminuted biomass 30 is distributed in the reaction channel 3 by a blower 20 (see FIG. 3), which provides a flow velocity 11 of a magnitude that ensures that the biomass 30 is distributed in the reaction channel 3. The flow velocity 11 further ensures that the carrier gas (by which the biomass 30 is transported) is recirculated in the reaction channel 3. The flow velocity 11 is selected in such a way that the biomass 30 used can be distributed in the reaction channel 3. If it is a question of for example comminuted straw, the required flow velocity 11 will for example be less than the flow velocity that is required to ensure that comminuted biomass 30 with a far higher density (e.g. poultry manure) is distributed in the reaction channel 3. In an embodiment, the flow velocity 11 is selected in the range 10-100 m/s, or 20-60 m/s, or 30-50 m/s.

In an embodiment, the oxygen concentration in the reaction channel 3 is kept low by injecting flue gas (from the burnt gas in the heating circuit 18) into the reaction channel 3. The heating of the heating circuit 18 can be controlled by regulating the gas flow velocity 15. As is the case for the reactor 2 shown in FIG. 1, the reactor in FIG. 2 is illustrated schematically. It will thus be possible to provide the reactor with several reaction channels 3, which are surrounded by heating circuit 18.

The reactor is characterized in that it can be started and stopped in a flexible manner, as the gasification of biomass 30 in the reaction channel 3 takes place when the oxygen content in the reaction channel 3 is kept at a low level simultaneously with the temperature in the reaction channel 3 being suitably high. It is thus possible to stop the production of pyrolysis gas very quickly by adjusting the feed of biomass 30.

In the same way as illustrated in FIG. 1, a plurality of nozzles 40, spaced apart, is provided in the heating circuit 18. The nozzles 40 are configured for supplying gas to the heating circuit to provide heating. By using the nozzles to feed gas into the heating circuit 18, it is possible to control both the amount of gas that is fed into the heating circuit 18 and the distribution of the gas feed. To prevent overheating of the heating circuit 18, the aim is to instal the nozzles 40 in such a way that the gas that is introduced via the nozzles is distributed evenly along the heating circuit.

On the left side of the section of the reaction channel 3 shown, there is a higher concentration of biomass 30 than in the right-hand part of the section of the reaction channel 3 shown. On the right-hand side of the section of the reaction channel 3 shown, there is a higher concentration of pyrolysis gas 28 and biochar (carbon) 105 than in the left side of the section of the reaction channel 3 shown, because the biomass 30 has been converted to pyrolysis gas 28 and biochar (carbon) 105, respectively.

FIG. 3 shows a schematic view of a reactor 2 according to an embodiment. The reactor 2 comprises a heat exchanger 4, which is in thermal contact with a heating circuit 18. It is one continuous heat exchanger 4, even if it is shown as two parts in FIG. 2. In an embodiment, the heat exchanger 4 and the surrounding heating circuit 18 are configured as described with reference to FIG. 1 and FIG. 2. Thus, in heat exchanger 4 there is a reaction channel 3, which forms a circuit, in which it is possible to provide recirculation of a carrier gas. The carrier gas is the pyrolysis gas that is produced in the reaction channel.

The reactor 2 comprises a feed section 6 for introducing comminuted biomass, which may for example be comminuted straw. Feed may advantageously be provided using a feed system as shown in FIG. 3.

An air blower 20 is installed in the reaction channel for recirculating carrier gas and distributing the biomass that is introduced via the feed section 6. Before the feed section 6, a gas preheater 10 is provided, the purpose of which is to increase the temperature of the carrier gas that is injected into the reactor 2 by the blower 20.

The function of the established heating circuit 18 (indicated with arrows) is to supply heat to the biomass in the reaction channel in the heat exchanger 4. The heat is supplied to the heating circuit 18 by recirculating hot combustion gas with a blower 8. Moreover, the necessary amount of gas and oxygen is added to maintain the desired heat production, which is required to provide pyrolysis production in the reaction channel.

Alternatively, the necessary amount of gas may be added to the recirculated combustion gas, while oxygen is supplied stepwise by a combustion air blower 14. The purpose of the vigorous recirculation and stepwise combustion is to increase heat transfer and prevent local overheating (hot spots) with the risk of burn-through of the reactor 2.

The reactor 2 comprises an air preheater 21, which heats the air from the combustion air blower 14. The heating circuit 18 is connected to the blower 8 that recirculates the hot combustion gas. The heating circuit 18 is further connected to the air preheater 21, so that the flue gas 12 is used for heating the injected air by heat exchange in the air preheater 21. The air preheater 21 is thus configured as a heat exchanger, which provides heating of the air that is introduced by the blower 14.

The reactor 2 may optionally comprise a heater 16, which generates the thermal energy for the heating circuit 18. The heater 16 may heat by electricity or by combustion of a fuel (gas, liquid or solid).

The reactor 2 comprises a preheater 10, the purpose of which is to raise the temperature of the recirculated carrier gas leaving the blower 20. This ensures that the temperature of the carrier gas is high enough for the pyrolysis process to take place as soon as the biomass is fed into the reaction channel.

The reactor 2 comprises a carbon separator 22, the uppermost part of which is connected to the outlet of the heat exchanger 4. The carbon separator 22 comprises a carbon outlet 24 and a pyrolysis gas outlet for withdrawal of pyrolysis gas 28. The pyrolysis gas 28 is withdrawn by ejection through the pyrolysis gas outlet, which is provided in the lowest part of the carbon separator 22. The pyrolysis gas 28 formed is led away via a pipe system (not shown) to a scrubbing process.

From the top of the carbon separator 22, the pyrolysis gas is recirculated further to the gas preheater 10.

A row of nozzles 40 is installed in the heating circuit 18. The nozzles 40 are installed and configured to be able to supply gas to the heating circuit 18 in such a way that the amount of gas that is fed into the heating circuit 18 and distribution of the gas in the heating circuit 18 may take place in such a way that the gas is distributed evenly in the heating circuit 18. It is thereby possible to avoid local overheating (hot spots) in the heating circuit 18. It is, moreover, advantageous for the nozzles 40 to ensure that the magnitude of temperature gradients in the heating circuit is minimized.

FIG. 4 shows a schematic diagram of a biomass feed unit 30 according to an embodiment. The purpose of the unit is to minimize the concentration of oxygen that is present in the biomass 30 that is fed into the reactor. A silo 97 is provided, equipped with an upper inlet 104, which in normal conditions is kept closed with a valve 103. This valve 103 is configured to be brought into an open configuration when biomass 30 is filled in the silo 97. In the lower part of the silo 97, an outlet is provided, which in normal conditions is kept open with valve 102. This valve 102 is configured to shut off the outlet when biomass 30 is filled in the silo 97.

Advantageously, a sensor (not shown) may be fitted, which measures the amount of biomass 30 in the silo 97. Measurements from this sensor may be used for controlling filling of biomass 30 in the silo 97.

To the left of the silo 97, a feed system is provided for introducing flue gas 98 with low oxygen content. This flue gas 98 may advantageously be derived from burning of the gas, which generates the heat that heats the reaction channels of the reactor by heat exchange with the heating circuit. The first valve 90 regulates supply of flue gas 98 to the silo 97. The second valve 90′ is a pressure reducing valve, which ensures that the silo 97 is pressurized with a pressure that is within a predefined range. Thus, an excess pressure (relative to the surroundings) is created in the silo 97. This excess pressure prevents atmospheric air entering the silo 97. It is thus possible to reduce the oxygen content in the silo 97. This minimizes the oxygen concentration in the gas that is fed together with the biomass 30 into the reaction channel.

The silo outlet opens out into a screw channel, in which there is a metering screw 92′, which is driven by an electric motor 100′. The activity (rotary speed) of the metering screw 92′ is decisive for how much biomass 30 is metered.

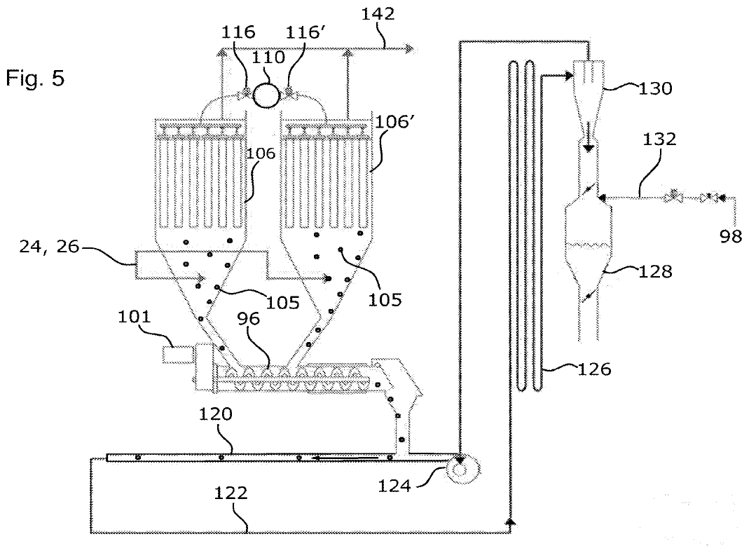

A flap 99 is provided, which opens when biomass 30 is propelled forwards towards the flap 99. The biomass 30 that passes through the flap 99 drops down into a lower screw channel, which houses a feed screw 92, which is driven by an electric motor 100. The activity of the metering screw 92′ determines how much biomass 30 is fed into the reactor (see FIGS. 1-3). The feed screw 92 is surrounded by a double-walled jacket 95, which is heated with hot pyrolysis gas 28 from a pipeline 142, which is the gas outlet from the filter system shown in FIG. 5. In this way, the screw 92 and the biomass 30 that the screw 92 propels into the reactor are heated. The heating of the feed screw 92 may alternatively be provided with flue gas from burning of gas in the heating circuit.

FIG. 5 shows a schematic view of a filter system for withdrawing and separating biochar according to an embodiment. The filter system comprises a first filter 106 and a second filter 106′, each comprising filter elements configured for filtration of carbon 105. Ceramic filter sticks may be used advantageously. The two filters 106, 106′ are placed in parallel and open out into a screw channel, which houses a screw 96, driven by an electric motor 101.

The screw channel opens out into a conveyor tube 120, which is connected to the blower 124, which blows carbon 105 into a cyclone 130 via a transport section 122. The transport section 122 is connected to a cooler 126, which may be placed advantageously in the open air. The cooler 126 is depicted as a tubular cooler 126, which cools the hot carbon 105 to prevent fire. It is thus possible to provide efficient cooling in a simple manner.

The cooler 126 is connected to the cyclone 130, which is configured to lead carbon 105 down into a carbon silo 128, which comprises an inlet and an outlet, each of which is equipped with a valve for opening and closing the carbon silo 128. A pipeline 132 is connected to the carbon silo 128. A system for supplying flue gas 98 is connected to this pipeline 132.

A gas supply unit 110, which may be configured as a gas holder, is placed above the filters 106, 106′. This gas supply unit 110 forms a part of the “backflush system” of the filter system, which operates by injecting gas from above and down into the filters 106, 106′, which provides cleaning of the filters 106, 106′. The “backflush system” of the filter system comprises a pipeline 142 configured for leading gas away. The “backflush system” of the filter system further comprises a first valve 116 for regulating the gas flow to the first filter 106 and a second valve 116′ for regulating the gas flow to the second filter 106′.

### REFERENCE NUMBERS

2 Reactor
3 Reaction channel
4 Heat exchanger
6 Feed section
8 Blower (combustion recirculation)
10 Preheater
11 Flow velocity
12 Discharge
14 Blower (combustion air)
15 Gas flow velocity
16 Heater
18 Heating circuit
20 Blower (gas recirculation)
21 Heat exchanger
22 Carbon separator
24 Carbon outlet
26 Gas (for the scrubbing process)
28 Pyrolysis gas
30 Biomass (e.g. straw)
40 Nozzle
90, 90′ Valve
92, 92′ Screw
95 Double-walled jacket
96 Screw
97 Silo
98 Flue gas
99 Flap
100, 100′, 101 Motor
102 Valve
103 Valve
104 Inlet
105 Carbon
106, 106′ Filter
110 Gas supply unit
116, 116′ Valve
120 Conveyor tube
122 Transport section
124 Blower
126 Cooler
128 Carbon silo
130 Cyclone
132 Pipeline
142 Pipeline (gas outlet)

What is claimed is:

1. A pyrolysis plant comprising:
a reactor for producing pyrolysis gas from biomass, the reactor comprising:
one or more reaction channels linked thermally with at least one heating circuit configured to heat the one or more reaction channels to a temperature that gasifies the biomass; and
a feed section configured for feeding the biomass into the one or more reaction channels;
a gas accelerator configured for recirculating the pyrolysis gas that is present in the one or more reaction channels and for generating a gas flow velocity that is able to distribute the biomass in the one or more reaction channels;
a carbon separator recirculating pyrolysis gas to a gas preheater from a top of the carbon separator; and
a plurality of nozzles provided in the heating circuit, each nozzle configured to supply gas to the heating circuit.

2. The pyrolysis plant according to claim 1, wherein the heating circuit is configured to carry out heating by burning gas.

3. The pyrolysis plant according to claim 1, further comprising an oxygen minimizing device in fluid communication with the feed section, wherein the oxygen minimizing device is configured to keep an oxygen concentration of air, which is fed together with the biomass into the one or more reaction channels via the feed section, below a predefined level.

4. The pyrolysis plant according to claim 3, wherein the oxygen minimizing device is in fluid communication with a pipe that receives flue gas from the heating circuit.

5. The pyrolysis plant according to claim 3, wherein the oxygen minimizing device is connected to or integrated in a feed system configured for feeding the biomass into the one or more reaction channels, the feed system comprising:
a silo for receiving, storing and supplying biomass;
a metering screw mounted rotatably in a first screw channel; and
a feed screw mounted rotatably in a second screw channel;
wherein the feed system is pressurizable.

6. The pyrolysis plant according to claim 1, wherein the one or more reaction channels comprise one or more ejection sections configured to release a portion of the pyrolysis gas when a gas pressure exceeds a predefined level.

7. The pyrolysis plant according to claim 1, wherein the gas accelerator is a blower mounted and configured for providing a gas flow velocity that disperses the biomass in the one or more reaction channels.

8. A method for producing pyrolysis gas from biomass, the method comprising:
providing a pyrolysis plant having:
a reactor comprising:
one or more reaction channels linked thermally with at least one heating circuit configured to heat the one or more reaction channels to a temperature that gasifies the biomass; and
a feed section configured for feeding the biomass into the one or more reaction channels;
a gas accelerator configured for recirculating the gas that is present in the one or more reaction channels and generating a gas flow velocity that is able to distribute the biomass in the one or more reaction channels;
a carbon separator recirculating pyrolysis gas to a gas preheater from a top of the carbon separator; and
a plurality of nozzles provided in the heating circuit, each nozzle configured to supply gas to the heating circuit; and
providing a gas flow that disperses the biomass in the one or more reaction channels.

9. The method according to claim 8, wherein the gas flow is provided by a blower installed in the one or more reaction channels.

10. The method according to claim 8, wherein the biomass is transported around in the reactor by a carrier gas, which is produced in the one or more reaction channels, wherein the carrier gas is recirculated in the one or more reaction channels.

11. The method according to claim 10, further comprising maintaining a temperature of the carrier in a predefined temperature range.

12. The method according to claim 10, further comprising increasing a temperature of the carrier gas in a section of the one or more reaction channels.

13. The method according to claim 10, further comprising keeping an oxygen concentration of the gas that is fed into the feed section below a predefined level, which is lower than an oxygen concentration of atmospheric air.

14. The method according to claim 8, wherein the pyrolysis plant further comprises an oxygen minimizing device in fluid communication with the feed section, wherein the oxygen minimizing device is configured to keep an oxygen concentration of air, which is fed together with the biomass into the one or more reaction channels via the feed section, below a predefined level.

15. The method according to claim 14, wherein the oxygen minimizing device is in fluid communication with a pipe that receives flue gas from the heating circuit.

16. The method according to claim 15, further comprising a step of pressurizing the feed system by introducing flue gas and closing the oxygen minimizing device.

17. The method according to claim 14, wherein the oxygen minimizing device is connected to or integrated in a feed system configured for feeding the biomass into the one or more reaction channels, the feed system comprising:
a silo for receiving, storing and supplying biomass;
a metering screw mounted rotatably in a first screw channel; and
a feed screw mounted rotatably in a second screw channel;
wherein the feed system is pressurizable.

18. The method according to claim 8, wherein the one or more reaction channels comprise one or more ejection sections configured to release a portion of the pyrolysis gas when a gas pressure exceeds a predefined level.

19. The method according to claim 8, further comprising continuously mixing the biomass within the one or more reaction channels.

20. The method according to claim 8, further comprising separating biochar from the pyrolysis gas.
